(19) United States
(12) Patent Application Publication
(10) Pub. No.: US 2025/0372331 A1
(43) Pub. Date: Dec. 4, 2025

(54) LED LAMP BEAD CHIP WITH DUAL-FUSE STRUCTURE AND PROGRAMMING METHOD THEREOF

(71) Applicant: Shenzhen HSG Electronics Co., LTD, Shenzhen (CN)

(72) Inventors: WEI SHEN, Shenzhen (CN); BO GUAN, Shenzhen (CN); ZONGZE YE, Shenzhen (CN)

(21) Appl. No.: 18/764,679

(22) Filed: Jul. 5, 2024

(30) Foreign Application Priority Data
Jun. 4, 2024 (CN) 202410715237.1

(51) Int. Cl. F21S 4/20; F21V 15/00; F21V 23/06; F21Y 103/10; F21Y 113/13; F21Y 115/10

(52) U.S. Cl. CPC H01H 85/05; F21V 15/00; F21V 23/003; F21Y 2113/13; F21Y 2115/10

(57) ABSTRACT

Disclosed are an LED lamp bead chip with a dual-fuse structure and a programming method thereof, the LED lamp bead chip includes an IC chip, a plurality of groups of logical addresses are arranged in the IC chip, at least two fuses are arranged between each group of logical addresses, and the logical address adopts OR gate logic. The programming method is as follows: the chip is irradiated by external light containing address information, a fuse located on a flag bit is blown, and logical information is transmitted to the chip to rewrite the corresponding internal logical value of the chip.

### CROSS-REFERENCE TO RELATED APPLICATIONS

This application claims priority to Chinese Patent Application No. 202410715237.1, filed on Jun. 4, 2024, which is hereby incorporated by reference in its entirety.

### TECHNICAL FIELD

The present disclosure relates to the field of LED lamp bead chips, and particularly relates to an LED lamp bead chip with a dual-fuse structure and a programming method thereof.

### BACKGROUND

At present, LED lamp bead chips on the market all adopt a single-fuse programming structure. In order to realize remote switching or color switching of a single lamp bead, it is usually necessary to blow the fuse corresponding to the ID address of a chip in the chip during programming, such that use status of a certain lamp bead can be separately controlled in the subsequent use. However, the single-fuse programming structure often encounters the problem of unsuccessful programming, which needs to be further improved.

### SUMMARY

An objective of the present disclosure is to provide an LED lamp bead chip with a dual-fuse structure and a programming method thereof, aiming to solve the problems that traditional LED lamp bead chip adopts a single-fuse programming structure, and is prone to programming failure during programming.

According to a first aspect of the present disclosure, an LED lamp bead chip with a dual-fuse structure is provided, the LED lamp bead chip includes an IC chip, a plurality of groups of logical addresses are arranged in the IC chip, at least two fuses are arranged between each group of logical addresses, and the logical address adopts OR gate logic.

According to a second aspect of the present disclosure, a chip programming method used for the LED lamp bead chip with a dual-fuse structure is provided, the programming method is as follows: the chip is irradiated by external light containing address information, a fuse located on a flag bit is blown, and logical information is transmitted to the chip to rewrite the corresponding internal logical value of the chip.

Further, a time-sharing fusing is adopted to preform fusing the fuse located on the flag bit.

According to a third aspect of the present disclosure, an LED lamp bead is provided, and the lamp bead has the LED lamp bead chip with a dual-fuse structure.

Further, the LED lamp bead has three monochromatic light-emitting units, and the three monochromatic light-emitting units are an R light-emitting unit, a G light-emitting unit and a B light-emitting unit, respectively.

Further, the three monochromatic light-emitting units are all electrically connected to a VDD pin, and are then electrically connected to a positive electrode of a power supply through the VDD pin.

Further, the LED lamp bead chip is electrically connected to a controller for controlling the LED lamp bead through a DIN pin, and the LED lamp bead chip is further electrically connected with the positive electrode and a negative electrode of the power supply through the VDD pin and a VSS pin, respectively.

Compared with the prior art, the present disclosure has the following beneficial effects:
1. Compared with a traditional LED lamp bead chip adopting a single-fuse programming structure, the LED lamp bead chip with the dual-fuse structure provided by the present disclosure is easier to succeed during programing, thereby effectively ensuring a success rate of information programming.
2. Since the LED lamp bead chip with the dual-fuse structure provided by the present disclosure adopts a dual-circuit fuse structure, a resistance in a programming circuit is reduced, and a programming current is increased, which is more conducive to improving the success rate of programming.
3. When the LED lamp bead chip is programmed according to the chip programming method provided by the present disclosure, all flag bits adopt a time-sharing fusing mechanism, which further ensures the success rate of address programming.

### BRIEF DESCRIPTION OF DRAWINGS

FIG. 1 is an initial state diagram of address logic and fuse structure of an LED lamp bead chip with a dual-fuse structure according to the present disclosure.

FIG. 2 is a first address logic diagram of successful programming of an LED lamp bead chip with a dual-fuse structure according to the present disclosure.

FIG. 3 is a second address logic diagram of successful programming of an LED lamp bead chip with a dual-fuse structure according to the present disclosure.

FIG. 4 is a structural schematic diagram of an LED lamp bead according to the present disclosure.

Reference numerals in the accompanying drawings: 1. LED lamp bead chip; 2. monochromatic light-emitting unit; 3. first fuse; and 4. second fuse.

### DETAILED DESCRIPTION OF THE EMBODIMENTS

In the present disclosure, unless otherwise explicitly specified and defined, the terms “mounting”, “connecting”, “connection”, “fixing”, etc. should be understood in a broad sense, for example, they may be a fixed connection, a detachable connection, or an integrated connection; may be a mechanical connection, or an electrical connection; may be a direct connection, or an indirect connection via an intermediate medium; and may be communication inside two elements, or an interactive relation between two elements. Those of ordinarily skilled in the art can understand specific meanings of the above terms in the present disclosure according to specific circumstances.

The present disclosure will be further described below in conjunction with the accompanying drawings and specific embodiments:

### Embodiment 1

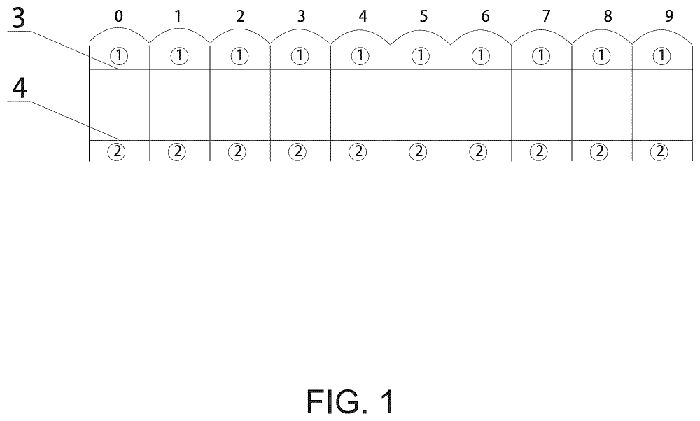

This embodiment provides an LED lamp bead chip with a dual-fuse structure, and an initial state diagram of an address logic and a fuse structure of the LED lamp bead chip is shown in FIG. 1. The LED lamp bead chip with a dual-fuse structure includes an IC chip, a plurality of groups of logical addresses are arranged in the IC chip, and at least two fuses are arranged between each group of logical addresses. In this embodiment, two fuses, that is, a first fuse 3 and a second fuse 4, are arranged between each group of logical addresses, and the logical address adopts OR gate logic.

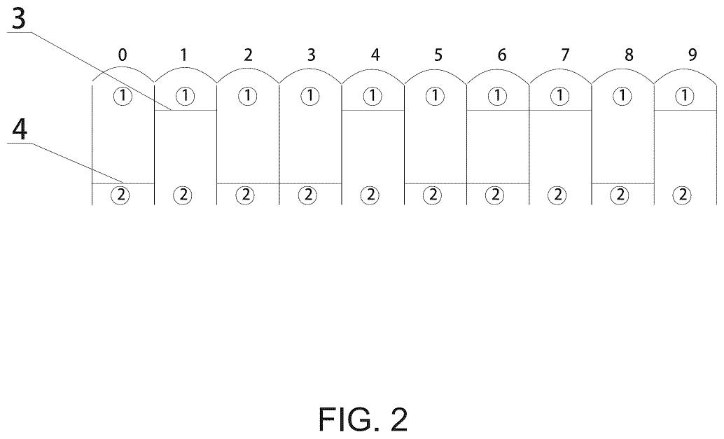

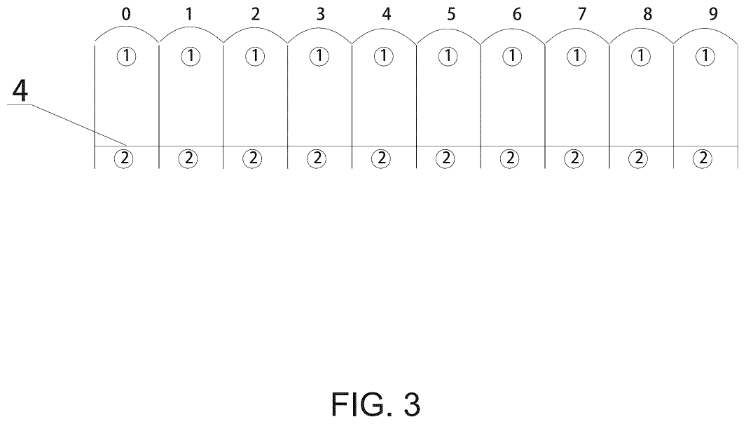

As shown in FIG. 1, a logical address of each IC chip is set to 10 groups, and the two fuses, that is, the first fuse 3 and the second fuse 4, are arranged between each group of logical addresses; and when a photoetching machine performs information programming, only two groups of fuses need to be blown, and any group thereof represents that the information programming succeeds, that is, successful programming. The IC chip logic also adopts the OR gate logic, also referred to as OR circuit, logic and circuit. When only one of many conditions is satisfied, an event will occur, and this relationship is called an “OR” logical relationship. A circuit having an “OR” logical relationship is called an OR gate. The OR gate has a plurality of input terminals and one output terminal, as long as one of the inputs is at a high level (logic “1”), the output will be at a high level (logic “1”). Only when all inputs are at a low level (logic “0”), the output will be at a low level (logic “0”). Therefore, the LED lamp bead chip with a dual-fuse structure provided in this embodiment has a plurality of structures for successful programming, as shown structures shown in FIGS. 2 and 3, but is not limited to the structures shown in FIGS. 2 and 3, and may also have other structures. Therefore, compared with a traditional LED lamp bead chip adopting a single-fuse programming structure, the LED lamp bead chip with the dual-fuse structure provided by the present disclosure is easier to succeed during programing, thereby effectively ensuring a success rate of information programming. In addition, since the LED lamp bead chip with the dual-fuse structure provided by the present disclosure adopts a dual-circuit fuse structure, a resistance in a programming circuit is reduced, and a programming current is increased, which is more conducive to improving the success rate of programming.

### Embodiment 2

This embodiment provides a programming method, which is used for the LED lamp bead chip with a dual-fuse structure provided in Embodiment 1. The chip programming method is as follows: the chip is irradiated by external light containing address information, a fuse located on a flag bit is blown, and logical information is transmitted to the chip to rewrite the corresponding internal logical value of the chip.

The principle is as follows: in the initial state, all chip codes are the same, and all logical values are zero; and after being exposed to external light containing address information, the LED chip, after sensing the light, transmits the logical information to the chip by using the photosensitivity characteristics, such that the corresponding internal logical value of the chip is rewritten. In this way, a purpose of reassigning a new address logic value to the LED light-emitting chip can be achieved.

In order to ensure the success rate of address programming, a mechanism for ensuring successful address programming is adopted, and all flag bits adopt a time-sharing fusing mechanism. Since the IC chip itself has been subjected to a dual-fuse structure for a unit address to improve a yield, and the yield of the fuse structure is superior to an erasable structure such as EEPROM, a structural yield of the present disclosure is superior to the erasable structure such as EEPROM.

### Embodiment 3

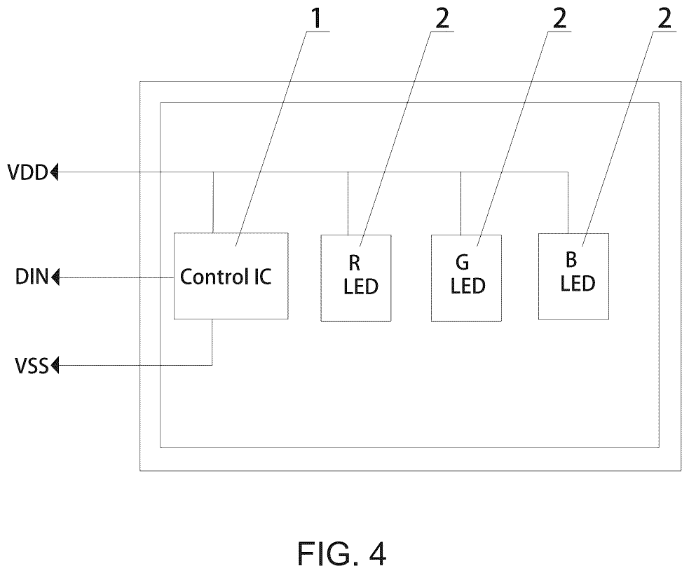

This embodiment provides an LED lamp bead, which has the LED lamp bead chip 1 with a dual-fuse structure provided in Embodiment 1. A structure of the LED lamp bead is shown in FIG. 4, the LED lamp bead includes an LED lamp bead chip 1 and three monochromatic light-emitting units 2, and the three monochromatic light-emitting units 2 are an R light-emitting unit, a G light-emitting unit and a B light-emitting unit, respectively. The three monochromatic light-emitting units 2 are all electrically connected to a VDD pin, and are then electrically connected to a positive electrode of a power supply through the VDD pin. The LED lamp bead chip 1 is electrically connected to a controller for controlling the LED lamp bead through a DIN pin, and the LED lamp bead chip 1 is further electrically connected with the positive electrode and a negative electrode of the power supply through the VDD pin and a VSS pin, respectively.

The above descriptions are only preferred embodiments of the present disclosure, and are not intended to be limiting of the present disclosure, and various changes and modifications may be made by those skilled in the art. Any modification, equivalent replacement, improvement, etc. made within the spirit and principle of the present disclosure shall fall within the protection scope of the present disclosure.

What is claimed is:

1. An LED lamp bead chip with a dual-fuse structure, comprising an IC chip, a plurality of groups of logical addresses are arranged in the IC chip, at least two fuses are arranged between each group of logical addresses, and one logical address adopts OR gate logic.

2. A chip programming method used for the LED lamp bead chip with a dual-fuse structure according to claim 1, wherein the chip is irradiated by external light containing address information, a fuse located on a flag bit is blown, and logical information is transmitted to the chip to rewrite a corresponding internal logical value of the chip.

3. The chip programming method for the LED lamp bead chip with a dual-fuse structure according to claim 2, wherein a time-sharing fusing is adopted to preform fusing the fuse located on the flag bit.

4. An LED lamp bead, comprising the LED lamp bead chip with a dual-fuse structure according to claim 1.

5. The LED lamp bead according to claim 4, wherein the LED lamp bead has three monochromatic light-emitting units, and the three monochromatic light-emitting units are an R light-emitting unit, a G light-emitting unit and a B light-emitting unit, respectively.

6. The LED lamp bead according to claim 5, wherein the three monochromatic light-emitting units are all electrically connected to a VDD pin, and are then electrically connected to a positive electrode of a power supply through the VDD pin.

7. The LED lamp bead according to claim 6, wherein the LED lamp bead chip is electrically connected to a controller for controlling the LED lamp bead through a DIN pin, and the LED lamp bead chip is further electrically connected with the positive electrode and a negative electrode of the power supply through the VDD pin and a VSS pin, respectively.
